(19) United States
(12) Patent Application Publication
(10) Pub. No.: US 2009/0265210 A1
(43) Pub. Date: Oct. 22, 2009

(54) Systems for Store Associate Management in a Store

(75) Inventors: Brett Bracewell Bonner, New Richmond, OH (US); Christopher Todd Hjelm, Cincinnati, OH (US); Titus Arthur Jones, Hebron, KY (US); Michael Aaron Jordan, Park Hills, KY (US); Dion Brent Perkins, Cincinnati, OH (US)

Correspondence Address: Theodore P. Cummings, Attorney at law, 1600 Scripps Center, 312 Walnut Street, Cincinnati, OH, 45202, US

(73) Assignee: THE KROGER CO., Cincinnati, OH (US)

(21) Appl. No.: 12/427,012

(22) Filed: Apr. 21, 2009

Related U.S. Application Data
(60) Provisional application No. 61/046,820, filed on Apr. 22, 2008.

(51) Int. Cl. G06Q 10/00; G06Q 50/00

(52) U.S. Cl. 705/9; 705/11

(57) ABSTRACT

Described herein is a system for managing at least one store associate in the operation of a store through wireless electronic communication through a communication network between a manager and at least one store associate. The manager uses a manager's communication device and the at least one store associate uses an associate's communication device to communicate through the communication network. The store associate is provided a list of orders to perform and the manager receives data on the manager's communication device pertaining to the performance of the list of orders created on the associate's communication device, wherein the manager uses said data to evaluate the job performance of the at least one store associate.

### CROSS REFERENCE TO RELATED APPLICATION

This patent application cross-references and claims priority to U.S. Provisional Patent Application No. 61/046,820 filed on Apr. 22, 2008, which is incorporated by reference herein.

### FIELD OF THE INVENTION

The invention relates to a system for managing store associates in a store. In particular, the invention allows a manager to electronically and wirelessly communicate in real-time through a communication network with store associates in the store, to know where the store associates are in relation to assigned tasks, to keep track of the amount of time a store associate spends on a given assigned task and to evaluate the effectiveness of tasks communicated to have been completed by a store associate.

### BACKGROUND OF THE INVENTION

Annually, many of today's retail stores experience nearly 100% turnover of their store associates. These retail stores often conduct exit surveys of the store associates that terminate their own employment. Exiting store associates reveal in exit surveys that they seek other employment because the store did not notify store associates regarding the accomplishment of tasks.

What is therefore needed is a low cost, highly effective, highly reliable system and method for (1) managing store associates that serves to simplify and expedite the process of completing tasks, (2) communicating clear objectives for store associates, (3) communicating recognition of accomplishment to the store associates as they complete tasks asked of them to complete, and (4) enhancing and simplifying the management of store associate duties with very little, if any, cost pass-through or negative impact to a store's profit margin. This has been achieved through one or more of the embodiments disclosed below and will now be explained with greater detail and particularity.

### SUMMARY OF THE INVENTION

Described herein is a system for managing the completion of orders in a retail environment. The system for managing the completion of orders includes a store having store personnel on duty within said store. Furthermore, the system for managing the completion of orders includes a communication network for electronic communication by the store personnel about said store. In addition, the system for managing the completion of orders includes at least one of said store personnel having a manager's communication device and at least one of said store personnel having an associate's communication device. In the system for managing the completion of orders, the store personnel communicate through the communication network to assign and complete a list of orders to be completed in the store.

Also provided herein is a system for managing the at least one store associate in the store. The system for managing the at least one store associate in the store includes a store having store personnel on duty within the store and a communication network for electronic communication by said at least one store personnel. The communication network is positioned about the store. The system for managing the at least one store associate in the store also includes at least one of said store personnel having a manager's communication device and at least one of said store personnel having an associate's communication device.

In the system for managing the at least one store associate in the store, the manager's communication device has a first memory for storing computer readable code, a first mechanism for creating a list of orders wherein said list of orders is to be conducted by said at least one store associate, and a first transmission device for transmitting said list of orders to said communication network.

In the system for managing the at least one store associate in the store, the associate's communication device includes a second memory for storing computer readable code, a second mechanism for creating a list of orders wherein said list of orders is to be conducted by said at least one store associate, and a second transmission device for transmitting said list of orders to said communication network.

In the system for managing the at least one store associate in the store, the at least one store personnel having said manager's communication device communicates through said communication network to assign a list of orders to the at least one of said store personnel having an associate's communication device, and said at least one of said store personnel having an associate's communication device completes the list of orders in said store.

### BRIEF DESCRIPTION OF THE DRAWINGS

While the specification concludes with claims particularly pointing out and distinctly claiming the invention, it is believed that the embodiments will be better understood from the following description in conjunction with the accompanying figures, in which:

FIG. 1 is a flowchart of an exemplary embodiment of the system of managing store associates through a communication network.

FIG. 2 is a flowchart of an exemplary embodiment of the system that a manager uses when managing store associates through a communication network wherein the store associate signals completion of his or her list of orders through scanning a barcode with his or her associate's communication device.

FIG. 3 is a flowchart of an exemplary embodiment of a system of managing store associates through a communication network wherein the store associate signals completion of his list of orders through his or her associate's communication device.

FIG. 4 is a flowchart of an exemplary embodiment of the system in which the manager has real-time data of store associates' locations within the store.

FIG. 5 is a flowchart of an exemplary embodiment of the system in which the manager has real-time data of store associates' locations within the store.

FIG. 6 is a flowchart of an exemplary embodiment of the system of managing store associates wherein a shopper signals a need for help.

### DETAILED DESCRIPTION OF THE SPECIFICATION

Provided herein is a system for managing store personnel. Also provided herein is a system for managing at least one store associate. Furthermore, described herein is a system for managing the completion of orders in a retail environment.

Each system comprises a communication network positioned about the store and associate's communication device used by the at least one store associate as well as a manager's communication devices used by the at least one manager. In exemplary embodiments, the communication network further comprises one or more network devices. Network devices include, for example, one or more communication devices, the associate's communication devices, the manager's communication devices, an associate task device, a data collections device, a gateway server, computers, servers, and electronic devices with processing abilities.

The system for managing the completion of orders in a retail environment is adapted for coordinating task management through an interactive wireless communication network, known herein as the communication network. The communication network provides wireless, electronic communication between at least one shopper, the at least one store associate and the at least one manager alike, but preferably the at least one shoppers will not communicate wirelessly over the communication network with another at least one shopper.

The term “communication device” as used herein means a handheld, battery-powered, electronic device, which is an exemplary network device, and is designed for communication through the communication network with other communication devices and network devices, and wherein each communication device is adapted to operate as a blind node and as an end node within the communication network. The communication device has the ability to seek out and associate itself (i.e., attach itself wirelessly) to the communication network. Exemplary communication devices are configured to create, receive, display and transmit one or more audio message, one or more video message and one or more text message.

In exemplary embodiments, the communication devices are equipped with a “location tracking device” and a “product scanning device”, but in other embodiments the communication devices are equipped with only one of the two. The term “location tracking device” as used herein means a device containing a location detection hardware module that can be used to receive signals from stationary reference nodes, which are information routers that have known locations within the communication network. The location tracking devices have the means of performing ray tracing calculations and blind node location calculations to determine its own location in relation to stationary reference nodes. In exemplary embodiments, the location of the location tracking device is continuously being communicated to the data network organizer. In exemplary embodiments, the location tracking device continuously communicates location tracking data to the associate task device. The term “product scanning device” as used herein means a device with the means of scanning barcodes.

The product scanning device is useful for scanning barcodes on items by store associate after he has completed a highest priority order from a list of orders sent to his associate's communication device, wherein the scanned barcode, serving as a completion signal, is sent to the associate task device and/or to the manager's communication device. The scanning of barcodes operates as a completion signal when the highest priority order involved the items with barcodes. For example, when the highest priority order is to stock shelves, scanning of the one or more barcodes associated with the items required to be stocked on the shelves serves as a completion signal when the barcode data is transmitted to the manager's communication device. As an alternative example, when the highest priority order is to find a product for the shopper, then the barcode data of the product sought after by the shopper serves as the completion signal that the store associate completed the highest priority order to find a product for the shopper.

The completion signal is meant to indicate to the at least one manager that either the highest priority order or the list or orders has been completed by the at least one store associate. Completion signals include, for example, an audio message, a text message, a photograph, and barcode data.

In exemplary embodiments, the communication device is a fully functional device, while in others they are reduced function devices, and in still other embodiments, a first selected group of communication devices are fully functional devices and a second selected group of communication devices are reduced function devices. The term “reduced function device” as used herein means a device comprising multiple interface keys, wherein the majority of the interface keys provide a requested transmission to or from the communication network instead of performing computational work. The term “fully functional device” includes those communication devices that comprise multiple interface keys, wherein the communication device performs the majority of the computational work requested when one presses one or more of the multiple interface keys. In exemplary embodiments, the communication device is a mobile phone equipped with certain applications and/or hardware that allows it to engage in communication through the communication network positioned about the store.

An exemplary communication device comprises at least one microcontroller unit (MCU). An exemplary MCU is a system-on-a-chip type of MCU. The MCU comprises a control unit, one or more registers, an amount of ROM, an amount of RAM and an arithmetic logic unit (ALU). In the reduced function type of the communication device, the ALU will be accessed very little, if at all, for any calculations within the communication device. In the full function type of communication device, the ALU will be accessed and therefore used for computations.

The term “associate's communication device” as used herein refers to the communication device used by the at least one store associate to communicate with other at least one store associates, the at least one manager and the at least one shopper through the communication network. The associate's communication device comprises an associate's communication device processor and an associate's communication device memory. The term “manager's communication device” as used herein means an electronic device, such as a communication device or a personal computer. The manager's communication device comprises a manager's communication device memory and a manager's communication device processor. The manager's communication device is an exemplary network device used by the manager to communicate with the at least one store associate and the at least one shopper through the communication network.

The term “associate task device” as used herein means one or more electronic devices, network devices, capable of storing, organizing, managing and routing data, including, for example, real-time location data, “lists of orders”, completion signals, barcode data, and other management software and data. The associate task device comprises an associate task device memory and an associate task device processor. In exemplary embodiments, the associate task device comprises one or more server grade computers that store, organize, manage and route data regarding manager created lists of orders and other management software and data, and is wired to a gateway server. In exemplary embodiments, the associate task device receives, organizes and stores copies of all data created on each manager's communication device and each associate's communication device.

In exemplary embodiments of the associate task device, the associate task device keeps a running list of all barcodes scanned by the store associate. The associate task device organizes the scanned barcodes with the store associate's list of orders given to him by the manager or automatically generated by and delivered to him from the associate task device. The manager then can review the barcode information received on her manager's communication device. With this information, the manager can monitor the progress of each store associate to see if he is achieving his goals.

The list of orders serves as clear objectives set by the managers, regardless as to whether the associate task device or the manager creates the list of orders, for the store associate to perform. In exemplary embodiments, the list of orders is a simple to-do list of tasks to be performed. In exemplary embodiments, the list of orders is a detailed to-do list of tasks for the store associate to perform, and wherein each order of the list of orders is given a priority code and an estimated period of time it should take the store associate to perform the order.

In exemplary embodiments, the manager is provided real-time data as to the location of each shopper, store associate and any manager who are subordinate to the manager receiving the real-time data. This is advantageous for several reasons. First, the manager analyzes the real-time location data to determine whether the store associates are completing their expected tasks in the correct location. For example, from the real-time location data, the manager recognizes whether the store associate failed at his task of stocking certain shelves based on the analysis of the real-time location data.

Second, with the real-time location data, the manager has more information to analyze the performance of the store associates, whom are subordinate to her in the store's hierarchy. The manager is has more information to make better decisions now that she has better information regarding the store associates. By analyzing this real-time location data, the manager is empowered to create more productive teams of store associates, which in turn increase profit margins.

Third, knowledge of real-time location of every shopper, store associate and manager is advantageous in the event that the store is named in a negligence slip and fall lawsuit, because the store will be able to provide hard data as to the location of appropriate parties at all times relevant to the suit. The store will be able to provide evidence of the store's routine management for spills and hazards, as well as the time when emergency sweeps are performed. Having real-time location data as evidence in such a suit eliminates certain expenses associated with discovery in litigation.

Moreover, the real-time location data and communication data will prevent unnecessary injuries, since the system empowers the manager of the store to alert the closest store associate to a known spill or other hazard to control the known spill or other hazard. After receiving the alert, the store associate safely controls the hazard to prevent injuries of shoppers and other store associates.

In exemplary embodiments, the real-time location data is gathered by the associate task device and transmitted through the communication network to the manager's communication device. The manager uses the real-time location data to make decisions in managing the store associates.

In exemplary embodiments, the associate task device uses the real-time location data received from the network devices to trigger the automatic generation and transmission of the list of orders to be sent to the manager and the store associates to be performed within the store. In exemplary embodiments, when the store associate sends an acceptance signal out through the communication network that he has accepted the list of orders, the associate task device (1) receives the acceptance signal and the real-time location data regarding the store associates and (2) automatically seeks to verify the performance of the list of orders being performed by the store associate. The associate task device, in these exemplary embodiments, alerts the managers in the event that the store associate is off task. The term “off task” as used herein means the store associate has signaled that he has accepted his list of orders, but he is not located in an area within or about the store to actually be performing the order from the list of orders.

In exemplary embodiments, the communication network comprises a data network organizer that routes information transmitted through the communication network to the network device which manages, organizes and stores data.

In exemplary embodiments, the communication network is a communication multi-network comprising either two or more similar communication networks or two or more dissimilar communication networks. An example of the communication multi-network comprising two or more dissimilar communication networks is a communication network comprising at least one mesh communication network and at least one star communication network, In said example of the communication multi-network, the at least mesh communication network is used for all network device communication, such as determining the location of communication devices, whereas the at least one star communication network is used for communicating all human-readable data.

In exemplary embodiments the system comprises an integration legacy system and a computer assisted ordering system. Thus, in such embodiments, the system is configured to schedule integrate and then schedule mobile applications as orders within the associate task device.

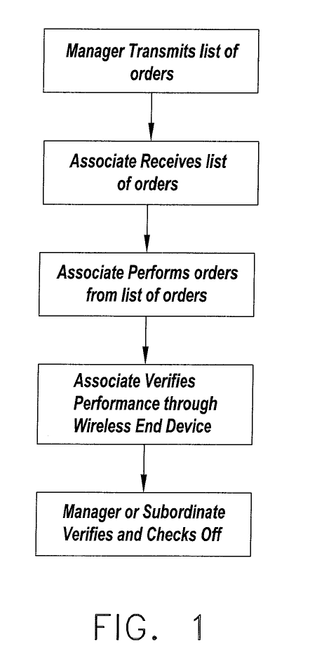

FIG. 1 is a flowchart of an exemplary embodiment of the system of managing store associates through the communication network. In this exemplary embodiment of the system, the manager creates a list of orders for a store associate. The manager transmits the list of orders from her manager's communication device to the store associate's communication device.

In exemplary embodiments, the associate task device processor, based on parameters established by the manager, automatically generates the list of orders to be automatically transmitted to the store associate upon a triggering event, such as the start of a new shift or the completion of a previously sent list of orders.

The store associate receives the list of orders on the associate's communication device. Then, the store associate performs the highest priority order from the list of orders. As the store associate completes the highest priority order from the list of orders, the store associate sends a completion signal that shows the manager that he has completed the highest priority order. The store associate sends the completion signal from the associate's communication device through the communication network to the manager's communication device. Ideally, the manager verifies that the store associate has completed the highest priority order, and the manager records on the manager's communication device that the highest priority order has been verified.

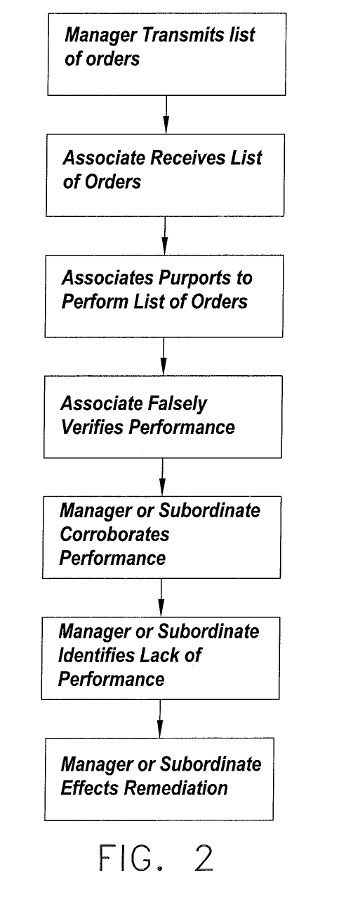

FIG. 2 is a flowchart of an exemplary embodiment of the system of managing store associates through the communication network. In this non-ideal system, the manager or a network device such as the associate task device creates a list of orders for a specific store associate. The manager transmits the list of orders to the specific store associate. Based on parameters established by the manager in the software of the manager's communication device or the associate task device, the associate task device may automatically generate the list of orders to be automatically transmitted to the store associate upon a triggering event, such as the start of a new shift or the completion of a previously sent list of orders.

The store associate receives the list of orders on the associate's communication device. The store associate accepts the highest priority order from the list or orders. The store associate purports to perform the highest priority order from the list of orders and after a period of time, the store associate sends the completion signal to the manager's communication device in an effort to communicate that he has completed the order asked of him to complete. The manager attempts to corroborate the performance of the store associate. However, the manager identifies a lack of performance and subsequently effects remediation.

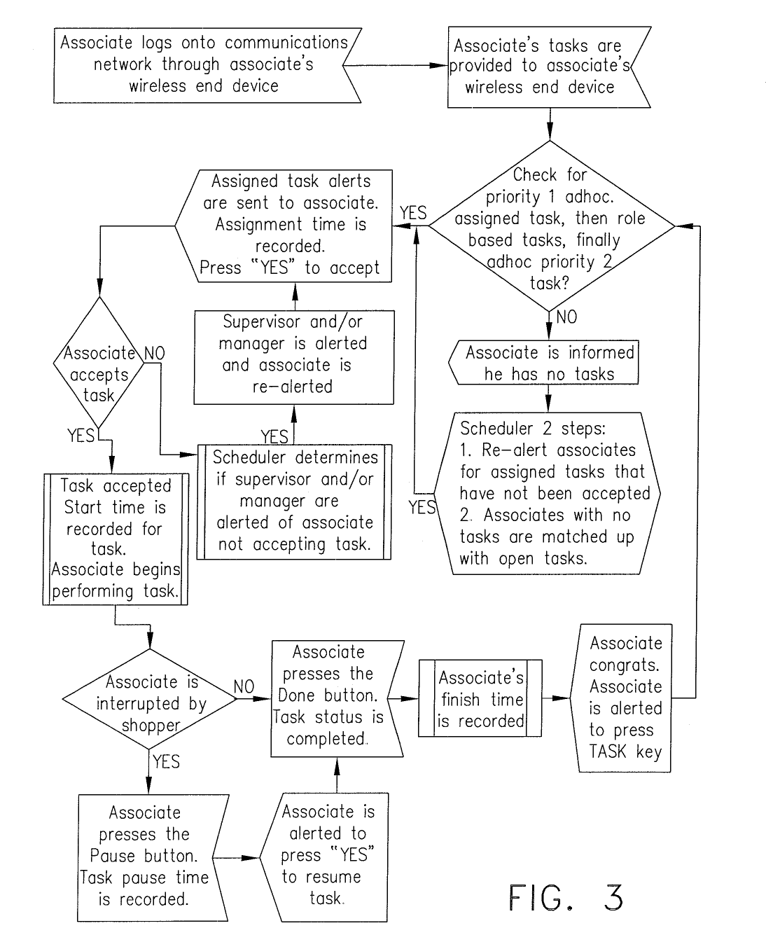

FIG. 3 is a flowchart of an exemplary embodiment of the system of managing store associates through a communication network positioned about the store. In this exemplary embodiment of the system, the store associate logs on to the communication network through the associate's communication device. The manager transmits the list of orders to the store associate. The store associate receives the list of orders on the associate's communication device. The store associate checks for the highest priority assigned order, looks at role based order, and lower priority orders. In exemplary embodiments, the store associate performs the highest priority orders before performing role based orders.

If there is not a list of orders on his associate's communication device, then the manager takes two steps: (1) she asks other store associates if they have unfilled orders that they have not begun working on at that point in time; and (2) the manager matches up the store associates without a list of orders with the open orders from other store associates' lists of orders.

Once the manager assigns the list of orders to the store associate, the associate's communication device receives an alert from the communication network that the store associate has an “assigned task”. The time the assigned task was delivered to the associate's communication device is called an “assignment time”. The assignment time is recorded on the associate task device and on the associate's communication device. Next, the store associate either accepts the assigned task or declines. To accept the assigned task, the store associate presses a button, for example an accept task button, located on the associate's communication device.

If the store associate does not press the accept task button within a pre-determined period of time, for example, three minutes, the manager's communication device is alerted and the associate's communication device is re-alerted regarding the receipt of the assigned task. In exemplary embodiments, a scheduling manager determines if the manager has been alerted that the store associate has not accepted his assigned task. After a pre-determined period of time, for example, six minutes, from the time of the assignment time, the manager resends the list of orders to the associate's communication device and asks the store associate to accept the assigned task. In exemplary embodiments, the manager chooses to effect appropriate remediation.

Once the store associate accepts the task assigned to him, a start time is recorded for the highest priority order. This start time may be recorded on the associate's communication device or on the associate task device. The timing data being created while the associate performs the highest priority order is called the total time of performance. In exemplary embodiments, when the associate accepts the highest priority order to perform from the list of orders received, an acceptance signal is transmitted to the associate task device. The acceptance signal is date and time stamped. In exemplary embodiments the associate task device compares the date and time stamp of the acceptance signal with the assignment time to create an assignment to acceptance timing data.

If none of the shoppers interrupt the store associate from performing his task, the store associate completes his task and sends a completion signal through the communication network to the manager's communication device. The completion signal is time and date stamped. The associate task device collects the start time and the completion signals. The manager's communication device has access to all data created by store associates whom she manages.

If, after the store associate accepts the highest priority order assigned to him and the start time is recorded for the highest priority order, the store associate is interrupted by the shoppers, then, ideally, the store associate presses a pause button located on the associate's communication device. Pressing the pause button is communicated to the associate task device and the manager's communication device. Pressing the pause button on the associate's communication device pauses the time recording function of the associate's communication device processor or the associate task device processor and pauses the generation of the total time of performance. At that point the store associate is alerted to press “yes” to resume completing the highest priority order on the associate's communication device. The store associate will press “yes” to resume completing the highest priority order once the store associate has finished helping the shopper that interrupted the store associate from performing the highest priority order.

After the store associate completes the highest priority order, the store associate signals completion of the highest priority order through the communication network to the manager's communication device. When the store associate signals completion of the highest priority order, the associate task device or the associate's communication device creates a total time of performance, which is the total time it took the store associate to complete the highest priority order. The one or more managers have access to the total time of performance to analyze and use to manage said store associate. After the store associate sends the completion signal to the manager's communication device, the associate's communication device receives a receipt that the completion signal was received. If at that time the store associate still has orders on the list of orders, the store associate performs the highest priority task on the list of orders. If there are not any unperformed orders on the list of orders displayed on the associate's communication device, the system described in FIG. 3 repeats.

In exemplary embodiments, the associate task device collects substantially all of the total time of performance for each individual store associate to create an employee performance data. The employee performance data is the mathematical average of substantially all of the total time of performance data entries recorded for an individual store associate on the associate task device. Said employee performance data is available to said manager through said manager's communication device for improved management of the store associate for optimal performance results.

In exemplary embodiments, the associate task device generates a store performance data from collecting and taking a mathematical average of substantially all the employee performance data from all of the store associates working for said store. Said store performance data is available to said manager of said store for improved management of said store associates.

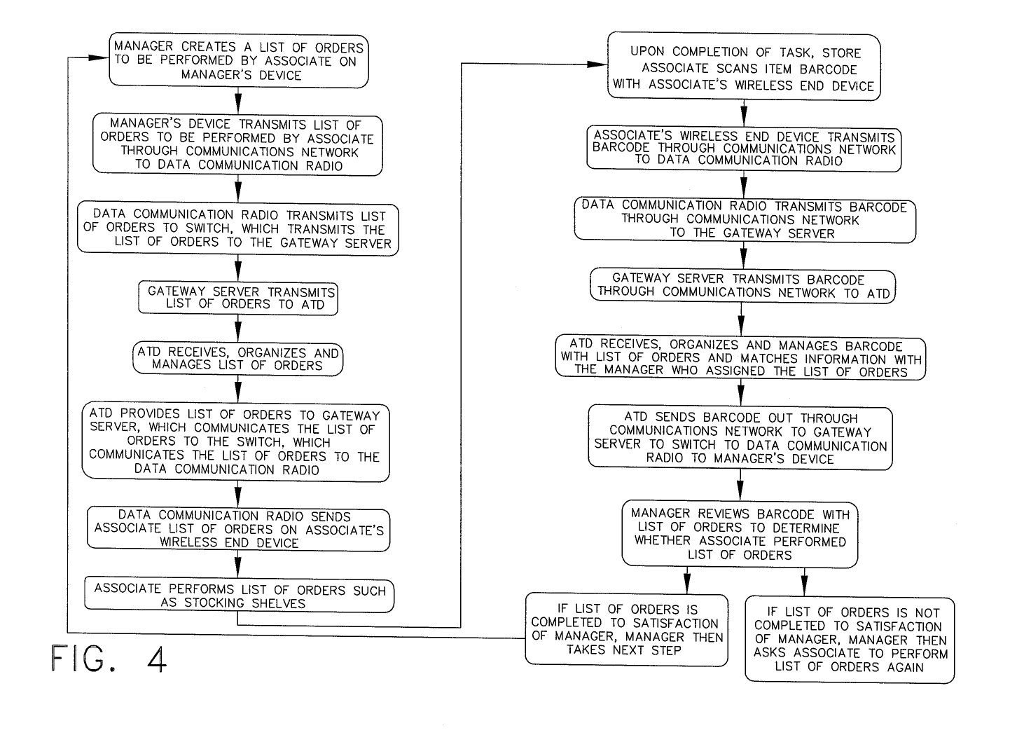

FIG. 4 is a flowchart of an exemplary embodiment of the system that the manager goes through when managing the store associates through the communication network wherein the store associate sends the completion signal of his list of orders through the scanning of the barcode with the product scanning device associated with the associate's communication device.

First, the manager creates a list of orders to be performed by the store associate on the manager's communication device. Next, the manager's communication device transmits through the communication network the list of orders to be performed by the store associate to the associate task device.

Second, the associate task device receives, organizes, and manages the list of orders. Then, the associate task device provides the list of orders to a server associated with the communication network. The server communicates the list of orders through the communication network and sends the list of orders to the associate's communication device.

Third, the store associate performs the list of orders, such as stocking shelves. Then, upon the completion of the order, the store associate transmits the completion signal to the manager's communication device. There are various embodiments of the completion signal, including for example, a barcode data, a text message, an audio file, a photograph and a video. In the embodiment wherein the completion signal is the barcode data, the store associate creates the completion signal by scanning with the product scanning device associated with the associate's communication device a barcode of one of the items stocked on one or more shelves. Next, the associate's communication device transmits the completion signal through the communication network to a data communication radio. Later, the data communication radio transmits the barcode data through the communication network to the gateway server. Then, the gateway server transmits the completion signal through the communication network to the associate task device.

Fourth, the associate task device receives, organizes, and manages the completion signal with the list of orders and matches the completion signal and list of orders with the manager's communication device that assigned the list of orders. Then, the associate task device sends the completion signal out through the communication network to the gateway server. The gateway server then sends the completion signal through the communication network to a switch. The switch then sends the completion signal through the communication network to the data communication radio. The data communication radio then sends the completion signal through the communication network to the manager's communication device.

Finally, the manager reviews the completion signal with the list of orders to determine whether the store associate performed the list of orders. If the list of orders is completed to the satisfaction of the manager, the manager then repeats the steps taken and described in FIG. 4. However, if the list of orders is not completed to the satisfaction of the manager, the manager then asks the store associate to perform the list of orders again.

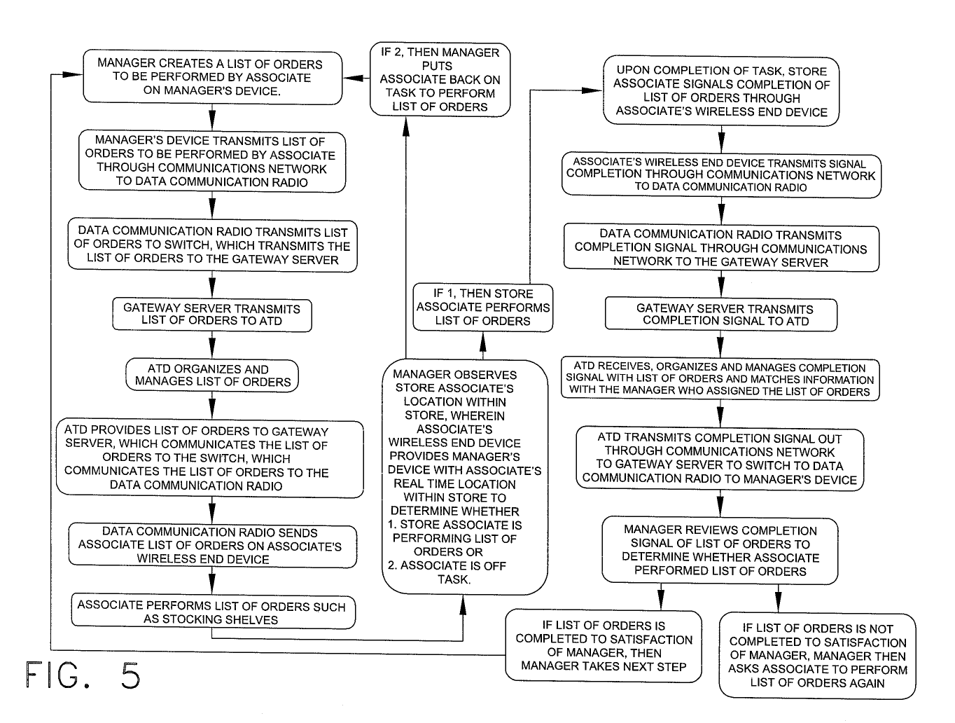

FIG. 5 is a flowchart of one embodiment of the system that a manager uses to manage the store associates wherein the manager is provided in real-time, a real-time location data pertaining to the one or more locations of the store associate.

First, the manager creates a list of orders to be performed by the store associate on the manager's communication device. Then, the manager's communication device transmits the list of orders to be performed by the store associate through the communication network to the data communication radio. Next, the data communication radio transmits the list of orders to the switch. The switch transmits the list of orders to the gateway server. Then, the gateway server transmits the list of orders to the associate task device.

Then, the associate task device organizes and manages the list of orders. Then, associate task device provides the list of orders to the gateway server. The gateway server communicates the list of orders to the switch, which communicates the list of orders to the data communication radio. Next, the data communication radio sends the list of orders to the associate's communication device. The store associate performs the list of orders such as stocking the shelves.

Next, the manager or a subordinate observes the store associate's location within the store, wherein the associate's communication device provides the manager's communication device the store associate's real-time location within the store in the form of “real-time location data”. Next, the manager or subordinate determines whether the store associate is performing the list of orders or whether the store associate is off task. At this point there are two scenarios. In the first the store associate is “off task” and in the second the store associate is “on task” and has performed the list of orders asked of store associate.

(1) If the store associate is off task, then the manager approaches (virtually or in reality) the store associate to guide the store associate back on task to perform the list of orders.

(2) The store associate is on task. Ideally, the store associate is performing the highest priority order on the list of orders. Ideally before the store associate begins performance of any order, the store associate creates and transmits an acceptance signal out from the associate's communication device to the associate task device. In exemplary embodiments, transmitting the acceptance signal starts the creation of the total time of performance on the timer associated with the associate's communication device. Once the store associate has completed performance of the orders he accepted, then the store associate creates a completion signal on the associate's communication device. Creating a completion signal completes the generation of the total time of performance. The store associate transmits the completion signal and the total time of performance through the communication network to the data communication radio. Next, the data communication radio transmits the completion signal through the communication network to the gateway server. Then, the gateway server transmits the completion signal to the associate task device.

For clarity, total time of performance may be generated (1) on the associate's communication device, (2) on the associate task device or (3) not generated at all, depending on the embodiment of the system. In the case where the total time of performance is generated on the associate task device, then the total time of performance is not transmitted out from the associate's communication device to the associate task device when the completion signal is transmitted out from the associate's communication device.

Next, the associate task device receives, organizes, and manages the completion signal with the list of orders. Next the associate task device matches the completion signal and the list of orders with the manager who assigned the list of orders. Then, the associate task device transmits the completion signal out through the communication network to the gateway server. The gateway server then transmits the completion signal out through the communication network to the data communication radio. The data communication radio then transmits the completion signal through the communication network to the manager's communication device. Next, the manager reviews the completion signal of the list of orders to determine whether the store associate performed the list of orders.

Finally, if the list of orders is completed to the satisfaction of the manager, the manager then repeats the process of assigning lists of orders again. However, if the list of orders is not completed to the satisfaction of the manager, the manager then asks the store associate to perform the list of orders again. Alternatively, the manager asks a different store associate to perform the list of orders and provides the store associate that did not perform the list of orders with feedback.

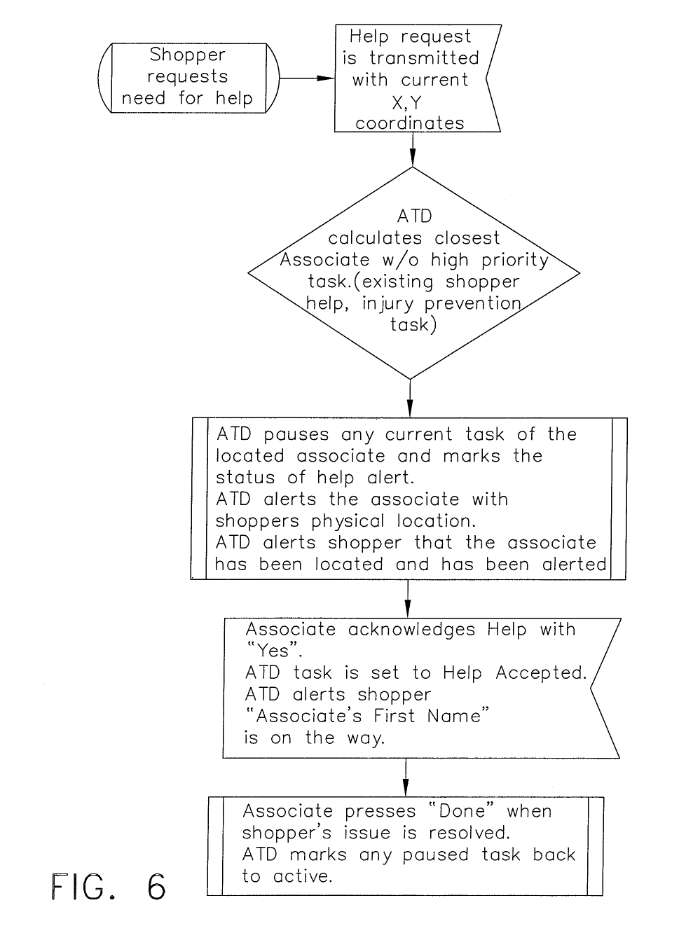

FIG. 6 is a flowchart of an exemplary embodiment of the system of managing the store associates wherein the shopper transmits a request help. In this embodiment the shopper transmits the request for help through the communication network from his communication device. The associate task device receives the shopper's request for help.

Next, the associate task device calculates the closest store associate without a high priority task, such as an existing alert that a shopper needs help or an injury preventive task. The associate task device pauses any current task of the located store associate and marks the status on his associate's communication device as “help alert”. The associate task device alerts the associate's communication device with the shopper's physical location in the store. The associate task device alerts the shopper's communication device that the store associate has been located and alerted. The store associate acknowledges that he has been assigned a “help task” and accepts the task through the associate's communication device. The signal of acceptance is transmitted through the communication network to the associate task device and starts a timer for the performance of the “help task”.

The store associate assists the shopper. After completion of assistance with shopper, the store associate signals that the “help task” is complete. Sending the “completion signal” to the associate task device stops the timer on the help task recording function and the associate task device records the time it took to help the shopper in the store associate's profile for the manager to review. The associate task device marks any paused task back to active to begin recording the time it takes the store associate to perform the order.

In exemplary embodiments, at the end of a predetermined period, such as a work shift or a week, the manager reviews the total time of performance and the employee performance data to evaluate each store associate's performance. The manager also uses the store performance data to determine the store's efficiency. In exemplary embodiments, the manager uses the store performance data for particular orders to determine how long each specific task ought to be taking. Furthermore, in exemplary embodiments, the manager uses the store performance data to better manage the operation of the store.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for managing the completion of orders in a retail environment, comprising:
a. A store having store personnel on duty within said store;
b. A communication network for electronic communication by said store personnel about said store;
c. At least one of said store personnel having a manager's communication device; and
d. At least one of said store personnel having an associate's communication device; whereby said store personnel communicates through said communication network to assign and complete a list of orders to be completed in said store.

2. The system of claim 1 wherein said store personnel comprises at least one manager and at least one store associate subordinate to said at least one manager.

3. The system of claim 2 wherein said at least one manager creates said list of orders on said manager's communication device and said manager's communication device transmits said list of orders to said associate's communication device through said communication network.

4. The system of claim 3 wherein said at least one store associate begins performing an order from said list of orders.

5. The system of claim 4 wherein said at least one store associate completes said order from said list of orders, creates a completion signal on said associate's communication device and sends said completion signal from said associate's communication device through said communication network to said manager's communication device.

6. The system of claim 5 wherein said manager manually or electronically corroborates store associate's performance of said order, from said list of orders.

7. The system of claim 1 wherein said associate task device creates a list of orders and transmits said list of orders to said manager's communication device and said associate's communication device through said communication network, said list of orders being transmitted in preparation for said at least one store associate's completion of the list of orders.

8. The system of claim 7 wherein said at least one store associate completes an order from said list of orders, creates a completion signal on said associate's communication device and sends said completion signal from said associate's communication device through said communication network to said manager's communication device.

9. The system of claim 8 wherein said manager manually or electronically corroborates said store associate's performance of said order from said list of orders.

10. The system of claim 8 wherein said manager receives the real-time location about the at least one store associate and wherein said manager uses said real-time location about said at least one store associate to corroborate said store associate's performance of said order from said list of orders.

11. The system of claim 7 wherein said at least one store associate chooses an order from said list of orders to accept by creating an acceptance signal such that said associate's communication device is equipped with a timer and wherein said timer is triggered to start recording time when said store associate transmits said acceptance signal from said associate communication device.

12. The system of claim 11 wherein said timer stops recording time when said at least one store associate creates a completion signal on said associate's communication device, and transmits said completion signal from said associate's communication device through said communication network to said manager's communication device such that said timer creates the total time of performance, and wherein said associate's communication device transmits said total time of performance through said communication network to said associate task device and said manager's communication device.

13. A system for managing at least one store associate in a store, comprising:
a. A store having at least one store personnel on duty within said store;
b. A communication network for electronic communication by said at least one store personnel, wherein said communication network is positioned about said store;
c. At least one of said store personnel having a manager's communication device, said manager's communication device having
i. A first memory for storing computer readable code;
ii. A first mechanism for creating a list of orders wherein said list of orders is to be conducted by said at least one store associate;
iii. A first transmission device for transmitting said list of orders to said communication network; and
d. At least one of said store personnel having an associate's communication device, said associate's communication device having
i. A second memory for storing computer readable code;
ii. A second mechanism for creating a list of orders wherein said list of orders is to be conducted by said at least one store associate;
iii. A second transmission device for transmitting said list of orders to said communication network; whereby said store personnel having said manager's communication device communicates through said communication network to assign a list of orders to the at least one of said store personnel having an associate's communication device, and said at least one of said store personnel having an associate's communication device completes the list of orders in said store.

14. The system of claim 13 wherein said store personnel comprises at least one manager and at least one store associate subordinate to said at least one manager.

15. The system of claim 14 wherein said at least one store associate completes said order from said list of orders, creates a completion signal on said associate's communication device and sends said completion signal from said associate's communication device through said communication network to said manager's communication device.

16. The system of claim 14 wherein said at least one manager manually or electronically corroborates the at least one store associate's performance of said order from said list of orders.
